(19) United States
(12) Patent Application Publication
(10) Pub. No.: US 2007/0042631 A1
(43) Pub. Date: Feb. 22, 2007

(54) SFP transceiver with one arm bail

(76) Inventors: Steve Xu Chen, Arlington Heights, IL (US); Bruce Peterson, Schaumberg, IL (US)

Correspondence Address: Karl D. Kovach, Esq.;Stratos International, Inc., 7444 West Wilson Avenue, Chicago, IL, 60706, US

(21) Appl. No.: 11/205,306

(22) Filed: Aug. 17, 2005

(51) Int. Cl. H01R 13/62

(52) U.S. Cl. 439/372

(57) ABSTRACT

The device includes a housing, a printed circuit board, a member, and a lever. The housing has a tab projecting from a surface of the housing. The printed circuit board mounted to the housing. The printed circuit board having contact traces. The member is moveable only in a translational direction and is positioned near the tab. The member having an actuation surface and is made of a rigid material. The lever is rotatably mounted to the housing. The lever having a rotatably mounted portion, a free end, a first portion, and a second portion. The second portion includes an arm for actuation by a user. The first and second portions each have respective heights and widths. Each of the height and width of the second portion is greater than the respective height and width of the first portion.

### BACKGROUND OF THE INVENTION

1. Field of the Invention

The present invention pertains to optoelectronic transceivers. The invention more particularly concerns a pluggable, optoelectronic transceiver having a bail which includes one arm.

2. Discussion of the Background

A pluggable, optoelectronic transceiver is known the art. U.S. Pat. No. 6,778,399 discloses a pluggable, optoelectronic transceiver having a wire lever actuator mechanism. U.S. Pat. No. 6,778,399 is hereby incorporated herein by reference. FIGS. 1-9 and the description below in this section are from U.S. Pat. No. 6,778,399.

FIGS. 1-3 show a pluggable transceiver module 10 having a release lever or bail actuator 12. The release lever 12 is located at a first end 14 of the transceiver module 10. A second end 16 of the transceiver module 10 is to be plugged into a host device or host receptacle 18 (FIGS. 4-6). A printed circuit board (PCB) 20 is exposed at the second end 16. The PCB 20 includes contact traces of a male portion of a card edge connector, or a male portion of a ribbon connector 22 for mating with a host receptacle.

A first side or bottom 24 of the transceiver module 10 includes a tab 26 that extends beyond the planer surface of the bottom 24. The surface of the tab 26 is inclined upwards towards the first end 14. The tab 26 is preferably triangular in shape. During insertion of the transceiver module 10 into a host receptacle, the tab 26 slides under a bendable portion, typically, into a slot on a host receptacle in order to lock the transceiver module 10 within a host receptacle.

In order to remove the transceiver module 10 from a host receptacle, a slidably mounted member or wedge 28 slides under a lip of a bendable portion on the host receptacle, such as illustrated in FIGS. 1-3 of U.S. Pat. No. 6,570,768. The member 28 separates the tab 26 from within a slot on a host receptacle, thus unlocking the transceiver module 10 from a host receptacle. U.S. Pat. No. 6,570,768 is hereby incorporated herein by reference.

The wedge or slidable member 28 is driven towards the tab 26 by rotating a free end 31 of the bail 12 outwards, away from the first end 14 of the module 10. The bail 12 includes a bump, bend, notch, or similar type of extension 30 on the rotatably mounted portion 32 of the bail 12. As the bail 12 rotates outward away from the face 38 of the module 10, the extension 30 is rotated, and force is applied to an actuation surface 34 on the member 28, thus driving the member 28 towards the tab 26. Inclined portions 36 on the member 28 fit under a lip of a bendable portion of the host device, separating the tab 26 from within a slot on the host device, and thus releasing the module 10 from a host device.

After the free end 31 of the bail 12 is rotated outward away from the face 38 of the module 10, which drives the member or wedge 28 towards the tab 26, the exposed free end 31 can be used as a handle by an operator to manually pull out the module 10 from within a host device. The outward rotated bail 12 functions as a handle to enable the module 10 to be removed, even if a spring release mechanism of the host device fails.

The release lever or bail 12 is constructed of a durable material, such as metal. The free end 31 of the bail 12 can include a roller 40 surrounding a portion of the free end 31. The roller 40 reduces rotational friction between the hand of an operator and the bail 12. The roller 40 is constructed of plastic or metal.

The rotatably mounted portion 32 of the bail 12 is mounted to the first side 24 of the module 10 using a mounting plate 42. Posts 44 located on the bottom or first side 24 of the module 10 fit into apertures 46 on the mounting plate 42 in order to properly align the mounting plate 42 to the first side 24. The mounting plate 42 can be secured to the first side 24 by gluing, sonic welding, or staking. The mounting plate 42 functions to secure the lever 12 and the slidable member 28 to the module 10.

The mounting plate 42 includes extensions 48 for rotatably mounting the bail 12 within a slot or notch 50 in the first side 24 of the module 10. The mounting plate 42 also includes extensions 49 for slidably mounting and guiding the slidable member or wedge 28 to the first side 24 of the module 10. The extensions 48 and 49 are formed in the mounting plate 42 by bending cut out portions of the mounting plate 42. The mounting plate 42 is constructed of metal or rigid plastic.

FIGS. 4, 5, and 6 illustrate multiple transceiver modules 10 having the first sides 24 mounted to opposing sides of a printed circuit board (PCB) 52. Grounding clips 54 of an EMI shield or cover 56 are in electrical contact with a faceplate 58 of the host device. The faceplate 58 includes square apertures 60 for properly positioning the modules 10 in a stacked arrangement. The faceplate 58 is made of metal and functions to provide a chassis ground for the modules 10 via the cover 56, which is in direct electrical contact with the faceplate 58.

FIGS. 7a, 7b, and 7c illustrate different angle views of the release lever or bail 12 shown in FIGS. 1-6. The extension or bend 30 is shown on the rotatably mounted portion 32 of the bail 12. The free end 31 is illustrated to include an open section 33, which enables the roller 40 to be easily installed on the free end 31. The bail 12 is formed out of a single piece of a metal rod or thick wire.

FIGS. 8a-8e illustrate different angle views of the slidable member or wedge 28 shown in FIGS. 1-6. The actuation surface 34 of the slidable member 28 is illustrated. The inclined portions 36 of the slidable member 28 are also illustrated. The slidable member 28 is formed from a single piece of metal.

FIGS. 9a-9d illustrate different angle views of the mounting plate 42 shown in FIGS. 1-6. The mounting plate 42 is constructed out of a single piece of metal. FIGS. 9a-9b illustrate the apertures 46 in the mounting plate 42. Also illustrated are the extensions 48 for securing the rotatably mounted portion 32 of the bail 12 within the notch 50 of the module 10. Similarly, extensions 49 of the mounting plate 42 is illustrated for slidably mounting the slidable member 28 on the first side 24 of the module 10.

When the lever 12 is in a locked position, as shown in FIG. 1, the handle or free end 31 is positioned adjacent to the housing and the bump 30 is positioned away from the housing. Also, the bump 30 contacts the actuation surface 34 of the member 28, and the member 28 is separated from the tab 26 by a first distance.

When the bump 30 contacts the actuation surface 34 of the member 28, when the lever 12 is rotated from the locked position to the un-locked position, the member 28 is moved closer to the tab 26. The member 28 is made of a substantially rigid material. Additionally, the member 28 is constrained between the mounting plate 42 and the housing. Thus, when the bump 30 applies a force to the member 28, the member 28 is only able to move in a direction substantially parallel to a length dimension direction of the housing. The member 28 is not able to substantially move in a direction perpendicular to the length dimension of the housing. Also, the manner in which the member 28 is retained between the mounting plate 42 and the housing, the member 28 is unable to rotate. Therefore, the member 28 can only translate in a direction substantially parallel to the length dimension of the housing.

When the lever 12 is in an un-locked position, the handle 31 is positioned away from the housing and the bump 30 is positioned adjacent to the housing. Also, the bump 30 contacts the actuation surface 34 of the member 28, and the member 28 is separated from the tab 26 by a second distance. Therefore, the first distance is greater than the second distance.

FIG. 10 is a side view of the transceiver module 10 mounted in a host device 70, where the host device 70 includes a recessed area 72. The recessed area 72 of the host device 70 makes it difficult for an operator to insert the transceiver module 10 into the host device 70. But of more concern is the removal of the transceiver module 10 from the host device 70. The recessed area 72 of the host device 70 makes it nearly impossible for the operator to remove the transceiver module 10 from the host device 70 having the recessed area 72. As can bee seen in FIG. 4, when the face plate 58 of the host device is relatively planar, the operator's finger can easily manipulate the bail 12 for easy removal of the transceiver module 10 from the host device. The host device 70 as shown in FIG. 10 does not allow for such easy removal. A dust plug 74 is plugged into the optical connector of the transceiver module 10.

Accordingly, there is a need for a transceiver module which is easily removable from a host device by an operator, where the host device has a recessed area.

### SUMMARY OF THE INVENTION

It is an object of the invention to provide a device which is easily removable from a host device by an operator, where the host device has a recessed area.

In one form of the invention the device includes a housing, a printed circuit board, a member, and a lever. The housing has a tab projecting from a surface of the housing. The printed circuit board mounted to the housing. The printed circuit board having contact traces. The member is moveable only in a translational direction and is positioned near the tab. The member having an actuation surface and is made of a rigid material. The lever is rotatably mounted to the housing. The lever having a rotatably mounted portion, a free end, and an arm for actuation by a user, the rotatably mounted portion having a bump, and the free end forming a handle. In a locked position of the lever, the handle is positioned adjacent to the housing and the bump is positioned away from the housing, and the bump contacts the actuation surface of the member, and the member is separated from the tab by a first distance. In an un-locked position of the lever, the handle is positioned away from the housing and the bump is positioned adjacent to the housing, and the bump contacts the actuation surface of the member, and the member is separated form the tab by a second distance, and the first distance is greater than the second distance.

In another form of the invention the device includes a housing, a printed circuit board, a member, a mounting plate, and a lever. The housing has a tab projecting from a surface of the housing. The printed circuit board mounted to the housing. The printed circuit board having contact traces. The member is moveable only in a translational direction and is positioned near the tab. The member having an actuation surface and is made of a rigid material. The mounting plate is attached to the housing. The mounting plate restricts the motion of the member in a direction perpendicular to a length of the housing so that the member is moveable relative to the tab and to the surface of the housing in only a translational direction. The motion of the member is substantially parallel to the length of the housing, and the motion is not in a rotational direction. The lever is rotatably mounted between the housing and the mounting plate. The lever having a rotatably mounted portion, a free end, and an arm for actuation by a user, the rotatably mounted portion having a bump, and the free end forming a handle. In a locked position of the lever, the handle is positioned adjacent to the housing and the bump is positioned away from the housing, and the bump contacts the actuation surface of the member, and the member is separated from the tab by a first distance. In an un-locked position of the lever, the handle is positioned away from the housing and the bump is positioned adjacent to the housing, and the bump contacts the actuation surface of the member, and the member is separated form the tab by a second distance, and the first distance is greater than the second distance.

Thus, the invention achieves the objectives set forth above. The invention provides a device which is able to be easily removed from a host device having a recessed area by a user.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a perspective view of an optical transceiver module having a release lever;

Figure is a perspective view of the transceiver module shown in FIG. 1 taken from a different angle;

FIG. 3 is a perspective view of the transceiver module shown in FIGS. 1, and 2 taken from yet another angle;

FIG. 4 is a side view of a circuit board having transceivers on the top and the bottom of the circuit board;

FIG. 5 is a perspective view of the circuit board and transceivers shown in FIG. 4;

FIG. 6 is an end view of the circuit board and transceivers shown in FIG. 4;

FIGS. 7a, 7b and 7c are perspective views of the release lever on the transceiver module shown in FIG. 1;

FIGS. 8a, 8b, 8c, 8d, and 8e are perspective views of the member on the transceiver module shown in FIG. 1;

FIGS. 9a, 9b, 9c, and 9d are perspective views of the mounting plate on the transceiver module shown in FIG. 1;

FIG. 10 is a side view of the transceiver module and a partial side view of the host device, where the host device includes a recessed area;

FIG. 11 is a side view of the transceiver module having a one arm bail and a partial side view of the host device, where the host device includes a recessed area;

FIG. 12 is a side view of the transceiver module having the one arm bail of FIG. 11;

FIG. 13 is a bottom view of the transceiver module having the one arm bail of FIG. 12;

FIG. 14 is a top view of the transceiver module having the one arm bail of FIG. 12;

FIG. 15 is a first end view of the transceiver module having the one arm bail of FIG. 12; and

FIG. 16 is a first end view of the transceiver module having the one arm bail of FIG. 12.

### DETAILED DESCRIPTION OF THE PRESENTLY PREFERRED EMBODIMENT

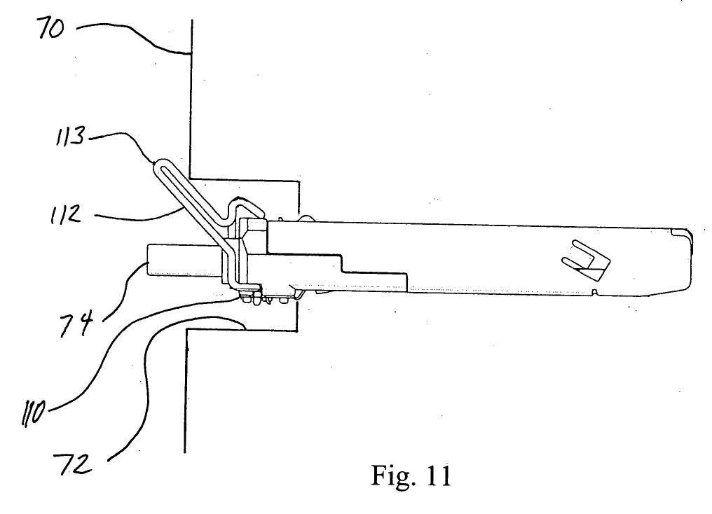

Referring now to the drawings, wherein like reference numerals designate identical or corresponding parts throughout the several views, and more particularly to FIGS. 11-16 thereof, an embodiment of the present invention is displayed therein.

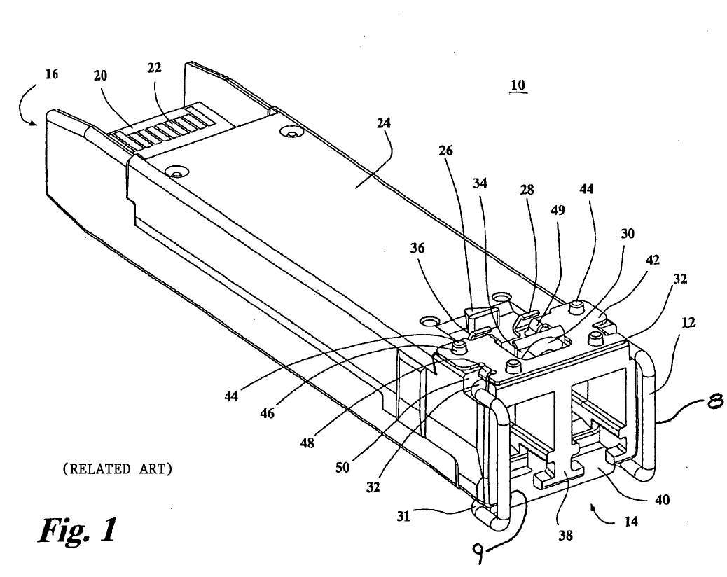

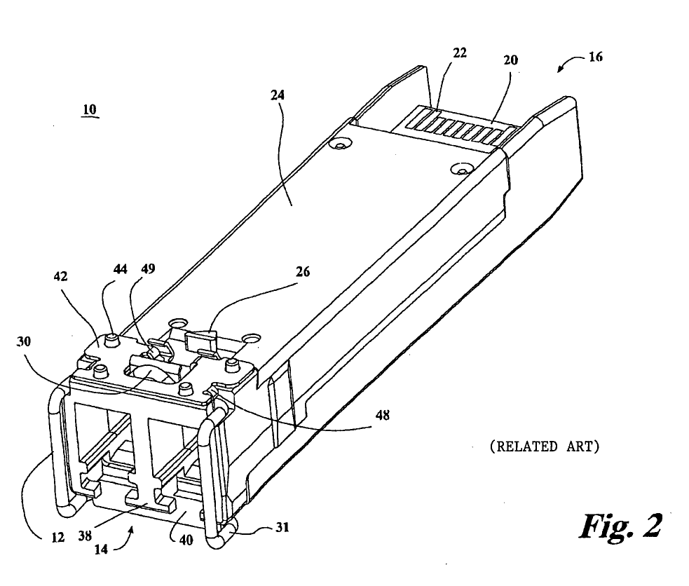

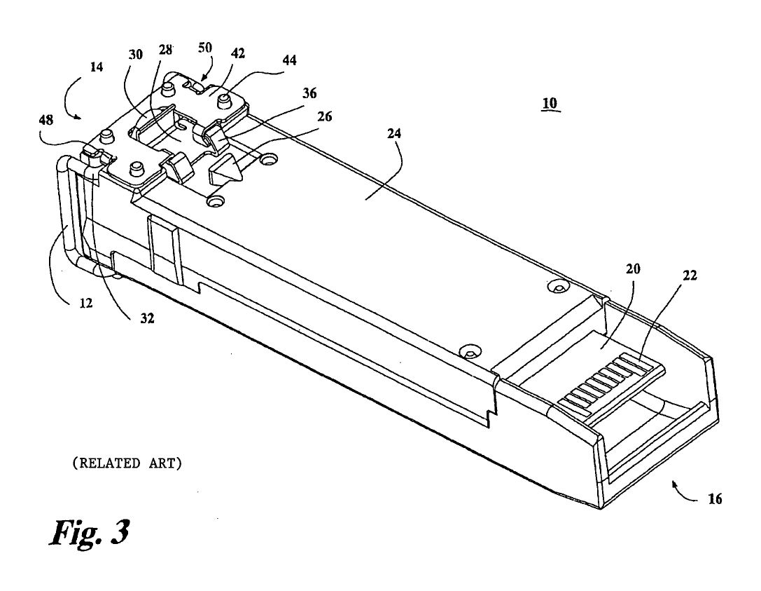

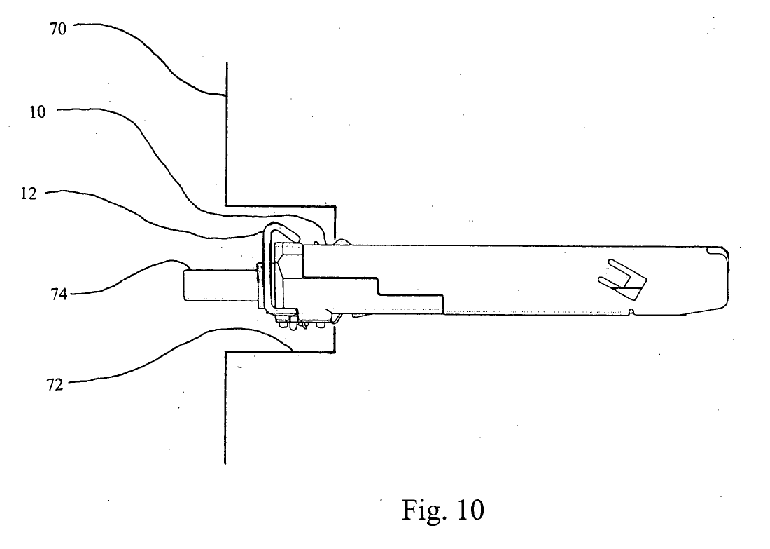

A first embodiment of the invention is shown in FIG. 11. FIG. 1 is a side view of the pluggable transceiver module or device 110 having a bail 112 with one arm 113, where the module 110 is plugged into a host device 70 having a recessed area 72. To remove the module 110 from the host device 70, an operator or user actuates the arm 113 by pushing the arm 113 down so that the handle or free end 31 moves away from the body of the module 110. As compared to the module 10, as shown in FIG. 10, the arm 113 of the bail 112 of the module 110, as shown in FIG. 11, is easily accessible by the user. Module 110 is substantially the same as the module 10 except for the presence of the arm 113 on the bail.

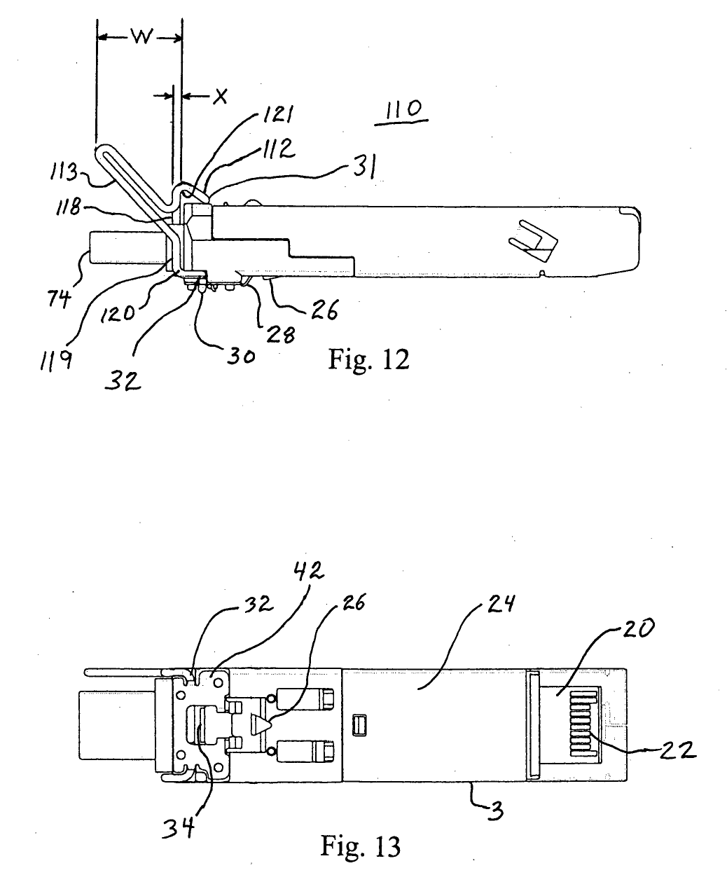

FIG. 12 is a side view of the pluggable transceiver module 110 separated from the host device. The pluggable transceiver module 110 includes a tab 26, a bail 112, and a wedge or slidably mounted member 28. The bail 112 includes the arm 113, the free end or handle 31, a rotatably mounted portion 32, and a bump, bend, or notch 30.

FIG. 13 is a bottom view of the pluggable transceiver module 110. Shown in more detail are a bottom or first side 24, a mounting plate 42, an actuation surface 34, the tab 26, a printed circuit board 20, and contact traces 22 on the printed circuit board 20 forming a male ribbon style connector of the pluggable transceiver module 110.

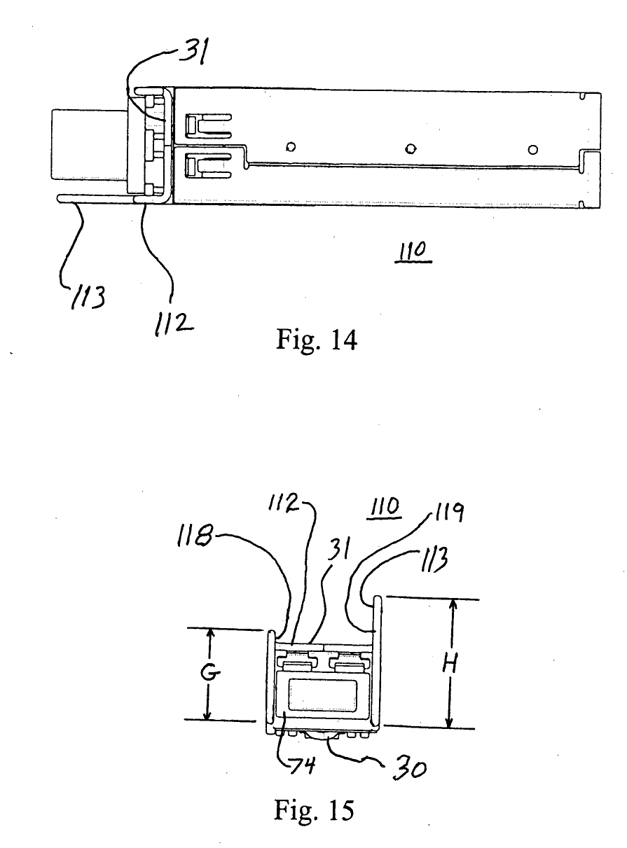

FIG. 14 is a top view of the pluggable transceiver module 110. Shown in more detail are the free end or handle 31 and the arm 113 of the bail 112.

FIG. 15 is an end view of the pluggable transceiver module 110 looking at the end of the pluggable transceiver module 110 that forms the optical connector. Shown in more detail are the free end 31, the arm 113, and the bump 30 of the bail 112.

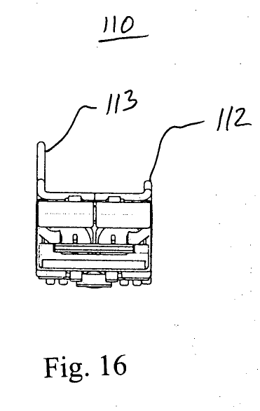

FIG. 16 is another end view of the pluggable transceiver module 110 looking at the end of the pluggable transceiver module 110 that forms the electrical connector. Shown in more detail is the arm 113 of the bail 112.

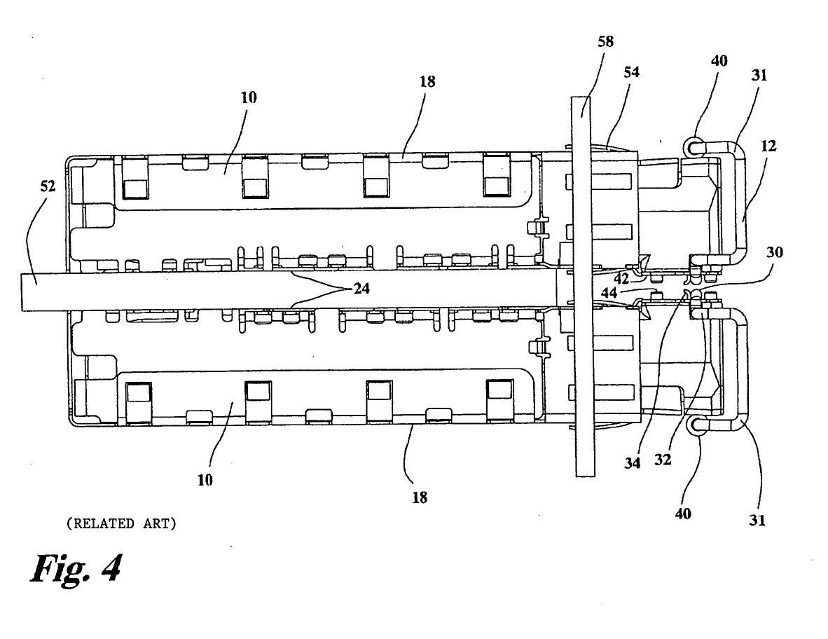

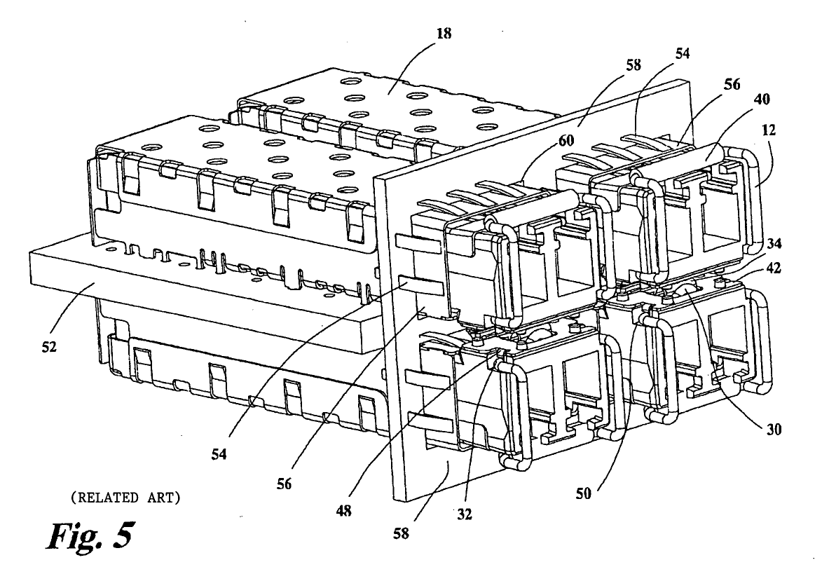

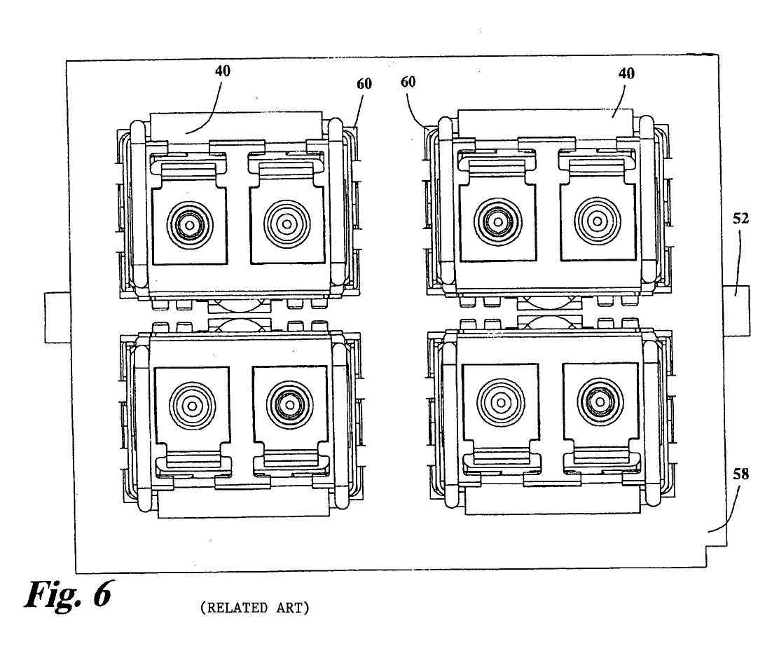

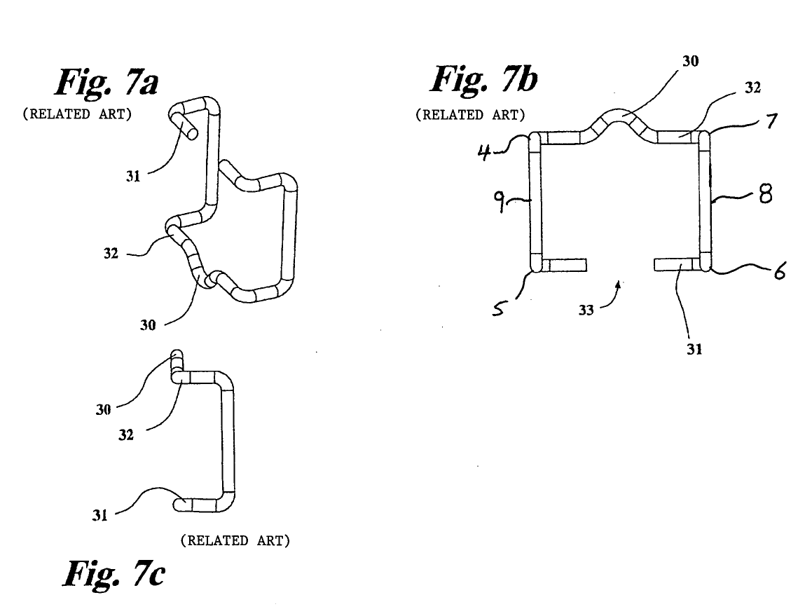

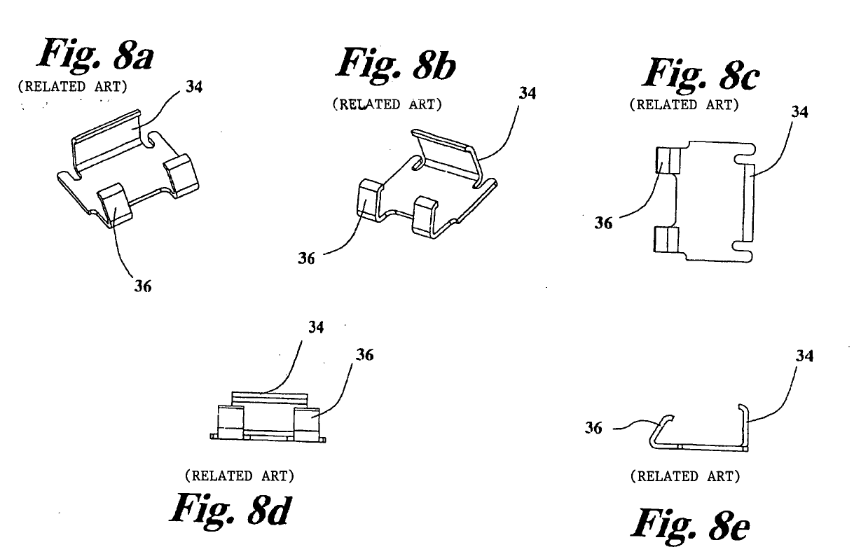

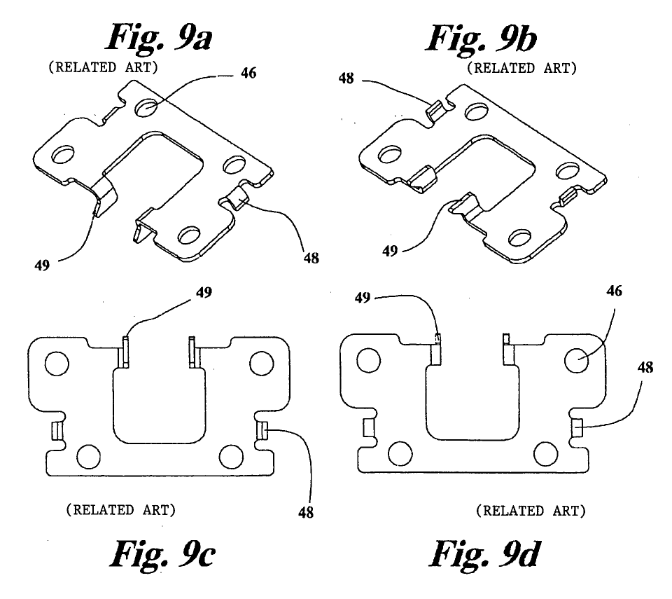

When locking or un-locking the pluggable transceiver module 110 from a host device 70, the interaction of the bail 112, including the rotatably mounted portion 32 and the bump 30, the slidably mounted member 28, including the actuation surface 34, the tab 26, and the features of the host device, interact in the same way as described above in regard to the pluggable transceiver module 10. The exception being when the pluggable transceiver module 110 is removed from the host device 70, the user actuates the arm 113, and when the user removes the pluggable transceiver module 10 from the face plate 58 form the host device (see FIG. 4) the user actuates the roller 40 at the free end 31 of the bail 112.

Obviously, numerous modifications and variations of the present invention are possible in light of the above teachings. It is therefore to be understood that within the scope of appended claims, the invention may be practiced otherwise than as specifically described herein.

1. A device comprising:
a housing having a surface, the housing having a tab projecting from the surface;
a printed circuit board mounted to the housing, the printed circuit board having contact traces;
a member positioned near the tab, the member having an actuation surface, the member moveable relative to the tab and to the surface of the housing in only a translational direction and not a rotational direction, the member made of a substantially rigid material; and
a lever rotatably mounted to the housing, the lever having a rotatably mounted portion, a free end, a first portion, and a second portion, the second portion including an arm for actuation by a user, the rotatably mounted portion having a bump, the free end forming a handle, the first portion having a height and a width, and the second portion having a height and a width, and wherein the height of the second portion is greater than the height of the first portion, and wherein the width of the second portion is greater than the width of the first portion, and wherein,
in a locked position of the lever, the handle is positioned adjacent to the housing and the bump is positioned away from the housing, and the bump contacts the actuation surface of the member, and wherein the member is separated from the tab by a first distance, and wherein,
in an un-locked position of the lever, the handle is positioned away from the housing and the bump is positioned adjacent to the housing, and the bump contacts the actuation surface of the member, and wherein the member is separated from the tab by a second distance, and wherein the first distance is greater than the second distance.

2. A device according to claim 1 wherein the lever is made of a metallic material.

3. A device according to claim 2 wherein the member is a made of a metallic material.

4. A device according to claim 2 wherein the member is made of a plastic material.

5. A device according to claim 1 wherein the member is a made of a metallic material.

6. A device according to claim 1 wherein the member is made of a plastic material.

7. A device comprising:
a housing having a surface, the housing having a tab projecting from the surface;
a printed circuit board mounted to the housing, the printed circuit board having contact traces;
a member positioned near the tab, the member having an actuation surface, the member made of a substantially rigid material;
a mounting plate attached to the housing, and wherein the mounting plate restricts motion of the member in a direction perpendicular to a length of the housing so that the member is moveable relative to the tab and to the surface of the housing in only a translational direction, which is substantially parallel to the length of the housing, and not a rotational direction; and
a lever mounted between the housing and the mounting plate, the lever being rotatable relative to the housing and the mounting plate, the lever having a rotatably mounted portion, a free end, a first portion, and a second portion, the second portion including an arm for actuation by a user, the rotatably mounted portion having a bump, the free end forming a handle, the first portion having a height and a width, and the second portion having a height and a width, and wherein the height of the second portion is greater than the height of the first portion, and wherein the width of the second portion is greater than the width of the first portion, and wherein,
in a locked position of the lever, the handle is positioned adjacent to the housing and the bump is positioned away from the housing, and the bump contacts the actuation surface of the member, and wherein the member is separated from the tab by a first distance, and wherein,
in an un-locked position of the lever, the handle is positioned away from the housing and the bump is positioned adjacent to the housing, and the bump contacts the actuation surface of the member, and wherein the member is separated from the tab by a second distance, and wherein the first distance is greater than the second distance.

8. A device according to claim 7 wherein the lever is made of a metallic material.

9. A device according to claim 8 wherein the member is a made of a metallic material.

10. A device according to claim 8 wherein the member is made of a plastic material.

11. A device according to claim 9 wherein the mounting plate is made of a plastic material.

12. A device according to claim 7 wherein the member is made of a metallic material.

13. A device according to claim 7 wherein the member is made of a plastic material.

14. A device according to claim 7 wherein the mounting plate is made of a metallic material.
